(19) United States
(12) Patent Application Publication
(10) Pub. No.: US 2024/0419952 A1
(43) Pub. Date: Dec. 19, 2024

(54) METHOD FOR OPERATING NEURAL NETWORK

(71) Applicants: TAIWAN SEMICONDUCTOR MANUFACTURING COMPANY, LTD., Hsinchu (TW); NATIONAL TSING HUA UNIVERSITY, Hsinchu City (TW)

(72) Inventors: Kea Tiong TANG, Taipei City (TW); Kuan-Pei LEE, Tainan City (TW)

(73) Assignees: TAIWAN SEMICONDUCTOR MANUFACTURING COMPANY, LTD., Hsinchu (TW); NATIONAL TSING HUA UNIVERSITY, Hsinchu City (TW)

(21) Appl. No.: 18/334,271

(22) Filed: Jun. 13, 2023

(51) Int. Cl. G06N 3/049; G06N 3/048

(52) U.S. Cl. CPC G06N 3/049; G06N 3/048

(57) ABSTRACT

A method is provided and includes operations as below: receiving an input in an input layer of a spiking neural network during time steps, wherein the input includes multiple spikes; generating, based on multiple activation values corresponding to the spikes, location information including count numbers each corresponding to non-zero values, in the activation values, in one of multiple rows of the input; performing, based on the location information, a matrix multiplication with the non-zero values in a first number of rows in the rows with a first group of filters of weight values to generate multiple first membrane potentials for outputting a first output spike; and performing, based on the location information, the matrix multiplication with the non-zero values in a second number of rows in the rows with the first group of filters of weight values to generate multiple second membrane potentials for outputting a second output spike.

### BACKGROUND

Deep neural networks (DNNs) are becoming increasingly popular in many applications, such as image recognition, natural language processing, and gaming. However, the demand for power-efficient acceleration hardware is also increasing, especially in emerging applications like robotics, IoT devices, and mobile communications. While there are scalable Convolutional Neural Network (CNN) processors and in-memory processing approaches, current AI chips designed for servers are still costly in terms of power consumption and hardware complexity.

To overcome this issue, using spiking neural network (SNN) algorithms that rely on low-power hardware, binary spikes, and sparse activation maps is proposed. Inspired by the human brain, SNNs use membrane potential to retain neuron information while minimizing inputs. However, SNN accelerators require additional time and buffers to perform more complex tasks, like high-resolution object detection, due to their extra time dimension information.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram illustrating an overview of a hardware accelerator for a spiking neural network, in accordance with some embodiments.

FIG. 2 is a flow chart of an example of a method for operating a spiking neural network operation, in accordance with some embodiments.

FIG. 3 illustrates a memory circuit storing activation values in the input feature maps, in accordance with some embodiments.

FIG. 4 illustrates a memory circuit storing location information, in accordance with some embodiments.

FIG. 5 illustrates an example embodiment of activation values in the input features maps to be convolved with filters, in accordance with some embodiments.

FIGS. 6A-6I illustrate an example embodiment of activation values in the input features maps to be convolved with filters, in accordance with some embodiments.

FIG. 7 is a block diagram illustrating an example of a data processing system used to implement a spiking neural network.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

As used herein, the terms “comprising,” “including,” “having,” “containing,” “involving,” and the like are to be understood to be open-ended, i.e., to mean including but not limited to.

Reference throughout the specification to “one embodiment,” “an embodiment,” or “some embodiments” means that a particular feature, structure, implementation, or characteristic described in connection with the embodiment(s) is included in at least one embodiment of the present disclosure. Thus, uses of the phrases “in one embodiment” or “in an embodiment” or “in some embodiments” in various places throughout the specification are not necessarily all referring to the same embodiment. Furthermore, the particular features, structures, implementation, or characteristics may be combined in any suitable manner in one or more embodiments.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. As used herein, the term “and/or” includes any and all combinations of one or more of the associated listed items.

As used herein, “around”, “about”, “approximately” or “substantially” shall generally refer to any approximate value of a given value or range, in which it is varied depending on various arts in which it pertains, and the scope of which should be accorded with the broadest interpretation understood by the person skilled in the art to which it pertains, so as to encompass all such modifications and similar structures. In some embodiments, it shall generally mean within 20 percent, preferably within 10 percent, and more preferably within 5 percent of a given value or range. Numerical quantities given herein are approximate, meaning that the term “around”, “about”, “approximately” or “substantially” can be inferred if not expressly stated, or meaning other approximate values.

Spiking neural networks (SNNs) transmit information between neurons in the form of spikes. This unique characteristic of SNNs can be used to create power-optimized neural networks, by utilizing a particular neuron model that suppresses activity in parts of the network. This allows SNNs to consume less power than other types of neural networks. The neurons within an SNN process input signals and produce output spikes. However, these spikes are not continuous values but binary activation values. They are produced when the membrane potential of a neuron exceeds a certain threshold, which can be determined by a thresholding model. The weights between neurons in an SNN determine the strength of their connections and are often modeled as filters that consider the timing of spikes. The membrane potential of a neuron represents the level of electrical charge inside the neuron, and when it reaches the threshold, the neuron fires a spike. These power-optimized neural networks may be implemented in a variety of different types of devices and/or systems including, but not limited to, consumer devices, servers, cloud server applications, and the like. For example, an SNN can be used in autonomous vehicles to recognize objects and make decisions based on their classification. The SNN can process the visual data from cameras and identify objects by analyzing the spatiotemporal pattern of spikes. In the medical field, an SNN can be used to analyze electroencephalography (EEG) signals and diagnose neurological disorders. The SNN can process the temporal dynamics of the EEG data and detect abnormal patterns that indicate a potential neurological condition.

This application relates to spiking neural networks. More particularly, the application relates to performing convolution operations on groups of filters sequentially to generate output spikes in a spiking neural network.

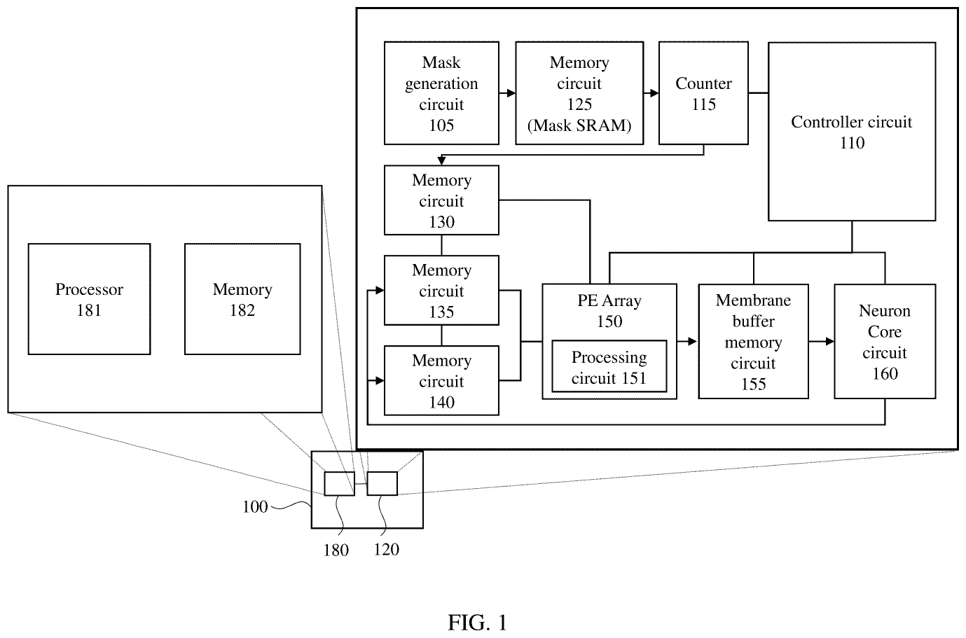

Reference is now made to FIG. 1. FIG. 1 is a schematic diagram illustrating an overview of the neural network processor 120 for a spiking neural network, in accordance with some embodiments. In some embodiments, the neural network processor 120 is on a die to form a neural chip (referred to as an accelerator chip). Several neural chips are packaged and networked together and included in any number of a devices 100, such like servers, mobile devices, sensors, actuators, etc. For illustration, in the embodiments of FIG. 1, the neural network processor 120 includes a mask generation circuit 105, a counter 115, a controller circuit 110, memory circuits 125, 130, 135, 140, a processing element (PE) array 150, and a neuron core circuit 160. In some embodiments, the PE array 150 includes multiple processing circuits 151.

In some embodiments, the neural network processor 120 is referred to as a programmable logic chip, implemented by System-On-a-Chip (SOC), coupled to a processing system 180 in the device 100, by a direct memory access (DMA) circuit. For example, the processing system 180 includes a processor 181 running programs to orchestrate the neural network operations in the neural network processor 120 via configuring a DMA circuit (not shown) to transfer data and instructions between a memory 182 on the processing system 180 and the neural network processor 120. In some embodiments, the processor 181 in the processing system 180 is implemented by a general-purpose processor, and the memory 182 stores data, instructions (programming codes), parameters corresponding to the spiking neural network processor 120.

The memory circuits 125, 130, 135, 140, and the membrane buffer memory circuit 155, in some embodiments, include static random access memory (SRAM) modules, dynamic random access memory (DRAM) modules, and/or flash memory modules. The memory modules include arrays of SRAM cells distributed across the memory arrays to provide an even distribution of memory cells for efficient use of the memory arrays. The memory arrays further include bit lines and word lines for selecting and accessing the SRAM cells. Additionally, the memory arrays include control circuits configured to control the read and write operations of the memory arrays. The memory array may further include a memory management unit configured to allocate memory resources and manage memory access operations for the neural network processor 120.

In some embodiments, the memory circuit 130 is configured to store groups of filters of weight values.

According to the embodiments of FIG. 1, the memory circuit 135 is configured to store a portion of the activation values of multiple time steps (e.g., time steps T1-T4), and the 140 is configured to store another portion of the activation values of the time steps. In some embodiments, the activation values correspond to multiple spikes in an input data received in an input layer of the spiking neural network during the time steps.

Furthermore, in some embodiments, each of the memory circuits 135 and 140 is configured as a “ping-pong” buffer that stores the output values generated by the neuron core circuit 160 according to activation values stored in the other one. Specifically, in some embodiments, the memory circuit 135 stores first output values corresponding to membrane potentials generated based on the portion of the activation values stored in the memory circuit 140. Similarly, the memory circuit 140 stores first output values corresponding to membrane potentials generated based on the portion of the activation values stored in the memory circuit 135. The configurations of FIG. 1 are given for illustrative purposes. Various implements are within the contemplated scope of the present disclosure. For example, in some embodiments, the memory circuits 135 and 140 are integrated into a single memory circuit, with the activation values being stored in separate memory banks within that memory circuit.

In some embodiments, the neural network processor 120 fetches/reads weight values and activation values from the memory 182 for neural network operation, and saves the weight values in the memory circuit 130 and the activation values in the memory circuits 135 and 140. The activation values may be included in input feature maps corresponding to multiple time steps.

The mask generation circuit 105 of the neural network processor 120 is configured to generate, according to the activation values, location information and further stores it into the memory circuit 125. In some embodiments, the location information includes count numbers each corresponding to the non-zero values in one of the rows of the input feature maps and channel numbers and height numbers, in which each of the channel numbers and a corresponding height number correspond to a location of one of the rows including at least one non-zero value.

The counter 115 is configured as an activation address calculator configured to analyze, based on the location information, locations (e.g., addresses) of memory cells that store the non-zero values in the memory circuits 135 and 140.

The controller circuit 110 is configured to send a control signal associated with the locations to the PE array 150 to read non-zero values as activations values to be analyzed in convolution operation in the PE array 150. Alternatively stated, only non-zero values will be read and transmitted to the PE array 150, which reduces computation resources and cycle times. In some embodiments, the controller circuit 110 is further configured to orchestrate all components in the neural network processor 120 by decoding instructions stored in other memory circuits in the neural network processor 120 or from the memory 182.

The processing element (PE) array 150 is configured to take charge of the majority of computation tasks in the spiking neural network processor 120, for example, including accumulation and comparison, based on the activation values and weight values accessed from the memory circuits 130, 135, and 140. For example, the processing circuits 151 of the PE array 150 are configured to perform, in response to the control signal associated with the locations provided by the location information, an activation operation (e.g., the convolution operation) on the non-zero values in the activation values stored in the memory circuits 135 and 140 alternatively with the weight values stored in the memory circuit 130 to generate membrane potentials to the membrane buffer memory circuit 155. The neuron core circuit 160 is configured to generate (fire) a spike(s) based on the membrane potentials in response to a control signal from the controller circuit 110.

Specifically, in some embodiments, when the processing circuits 151 performs the activation operation on the non-zero values from the memory circuit 135 with the weight values to generate membrane potentials and the neuron core circuit 160 generate a spike correspondingly, the memory circuit 140 stores the value(s) of the spike(s). On the other hand, when the processing circuits 151 performs the activation operation on the non-zero values from the memory circuit 140 with the weight values to generate membrane potentials and the neuron core circuit 160 generate a spike correspondingly, the memory circuit 135 stores the value(s) of the spike(s).

In some embodiments, the filters of weight values are divided into N groups. The processing circuits 151 are further configured to perform the activation operation on parts of activation values with one group of filters of weight values to generate portions of membrane potentials. In some embodiments, each of the N groups includes M number of filters. A number of the processing circuits 151 is associated with the number M and a dimension of kernels of the filters. In some embodiments, the number of the processing circuits 151 is a product of the number M and the dimension of kernels of the filters. For example, the dimension of the kernels of the filters is 3×3, and the number M equals to 32. Accordingly, the PE array 150 includes 96 processing circuits 151.

In some embodiments, the work of processing functions of the spiking neural network is configured to be divided between the components in the neural network processor 120.

The configurations of FIG. 1 are given for illustrative purposes. Various implements are within the contemplated scope of the present disclosure. For example, in some embodiments, the neural network processor 120 further includes other memory circuits configured to store and provide operation parameters of the spiking neural network, such likes, a predetermined count value, and a threshold value for determination of firing output spikes.

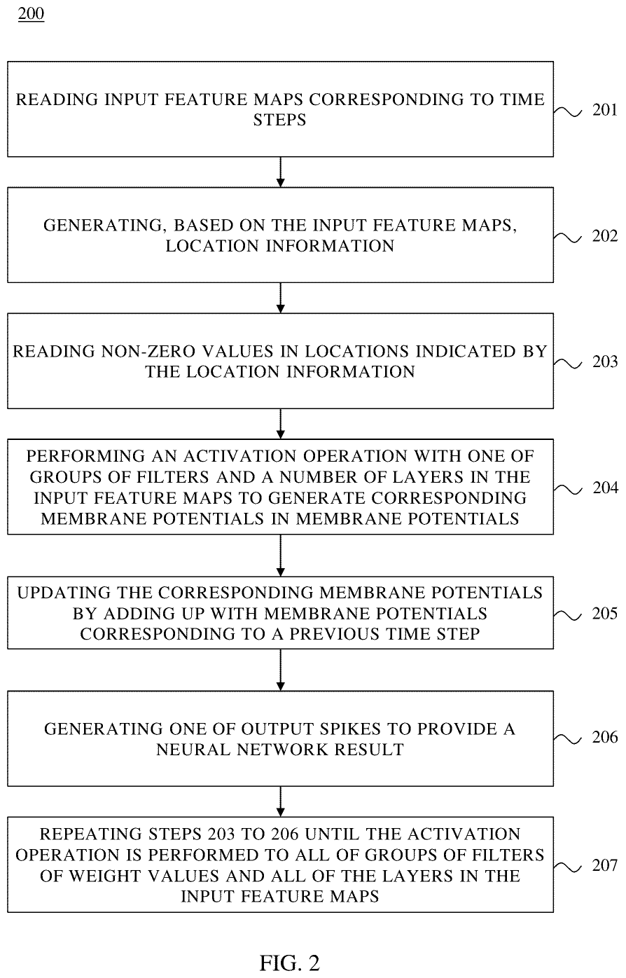

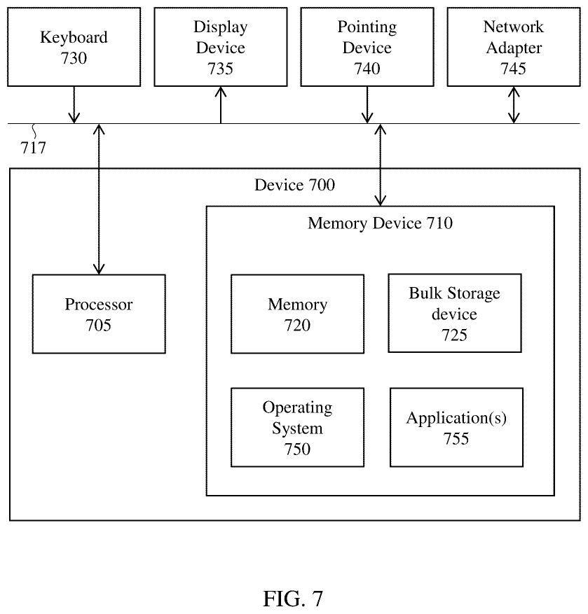

Reference is now made to FIG. 2. FIG. 2 is a flow chart of an example of a method 200 for operating a spiking neural network operation, in accordance with some embodiments. In some embodiments, the method 200 is implemented by the device 100 of FIG. 1 and a device 700 of FIG. 7. It is understood that additional operations can be provided before, during, and after the processes shown by FIG. 2, and some of the operations described below can be replaced or eliminated, for additional embodiments of the method 200. The method 200 includes operations 201-207 that are described below with reference to FIGS. 1-6I.

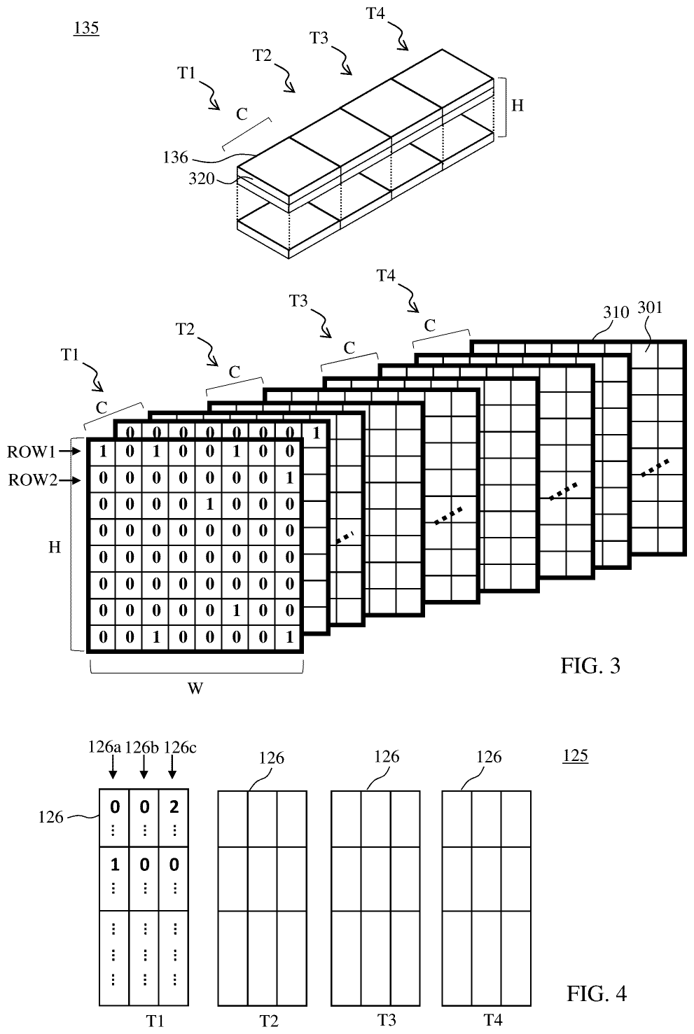

In operation 201, as shown in FIG. 3, multiple input feature maps 310 corresponding to time steps T1-T4 are read from a memory device, for example, the memory 182, and are stored by time steps in the memory circuit, for example, the memory circuit 135 of FIG. 1. In some embodiments, the input feature maps correspond to a number C of channels receiving the input spikes in the input layer of the SNN and has a dimension of a height H times a width W. For example, in each of the time steps T1-T4 are 64 channels and the dimension of the input feature map is 32 (rows) times 32 (columns), and accordingly, the number C equals to 64, the height H equals to 32, and the width equals to 32. Each of the input feature map 310 includes input elements 301 having activation values (e.g., “0” or “1”) arranged in 32 rows and 32 columns. In some embodiments, activation values in same row of the input feature map 310 for one time step are referred to as a layer 320 of the input feature map 310. As illustratively shown in FIG. 3, the layers 320 corresponding to the same time step are stored in a same segment 136 in the memory circuit 135. In some embodiments, all activation values of the time steps T1-T4 of the same input layer of the SNN are stored in sequence. For the sake of brevity, only a few rows and columns of the input feature maps 310 are shown for illustrative purposes.

In operation 202, the location information, based on the activation values in the input feature maps 310, is generated and stored in segments 126 of the memory circuit 125, as shown in FIG. 4, in which the segments 126 correspond to the time steps T1-T4 separately. In some embodiments, the segment 126 includes portions 126a-126c. The portion 126a is configured to store channel numbers that include, for example, 6 bits for each of the channel number. The portion 126b is configured to store height numbers that include, for example, 5 bits for each of the height number. The portion 126c is configured to store count numbers that include, for example, 5 bits for each of the count number.

With reference to FIGS. 3-4 together, the mask generation circuit 105, for generating the location information, fetches the input feature maps 310 by the time steps and counts the non-zero values in the input feature map 310 row by row and channel by channel to generate the count numbers in the location information. The mask generation circuit 105 further reads the channel number and the height number that corresponds to a location of the row including at least one non-zero activation value.

Specifically, for example, the first row ROW1 in the input feature map 310 of a first channel corresponding to the time step T1 includes a total of 3 non-zero values. Accordingly, a channel number having a value “0” corresponding to the first channel is stored in the first row of the portion 126a, a height number having a value “0” corresponding to the first row is stored in the first row of the portion 126b, and a count number having a value “2” corresponding to the 3 non-zero activation values is stored in the first row of the portion 126c. Similarly, the first row ROW1 in the input feature map 310 of a second channel corresponding to the time step T1 includes a total of 1 non-zero value. Accordingly, a channel number having a value “1” corresponding to the second channel is stored in a corresponding row of the portion 126a, a height number having a value “0” corresponding to the first row is stored in the corresponding row of the portion 126b, and a count number having a value “0” corresponding to the 1 non-zero activation values is stored in the corresponding row of the portion 126c.

For the sake of understanding, the values in the location information in FIG. 4 are schematically presented in decimal form. It should be noticed that the location of a row including none of non-zero values would not be recorded in the location information.

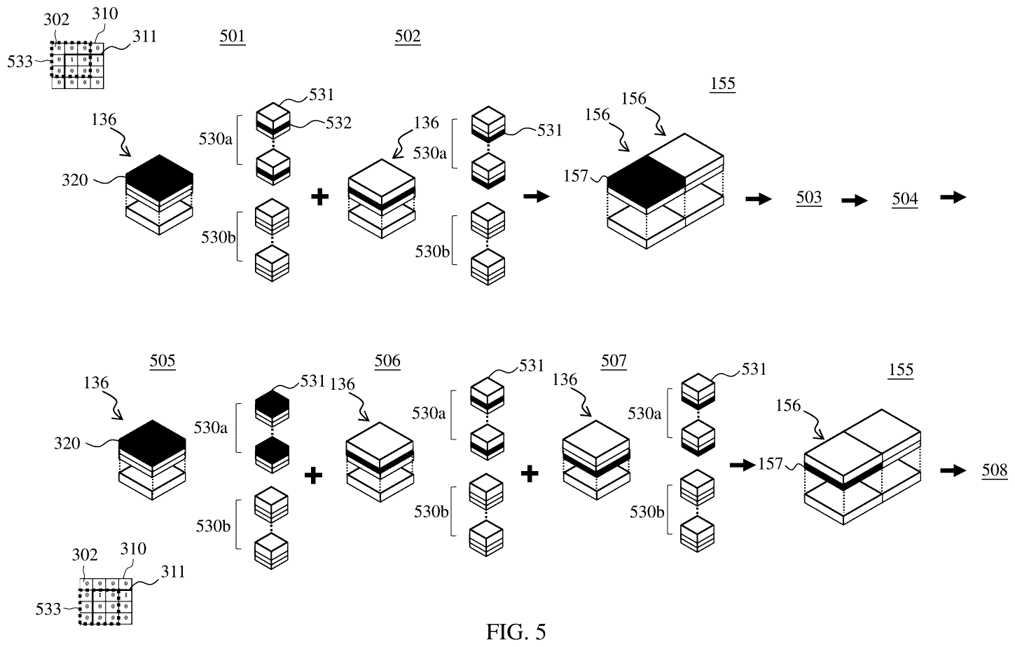

Reference is now made to operation 203 and FIG. 5. FIG. 5 illustrates an example embodiment of activation values in the input features maps 310 to be convolved with filters of weight values, in accordance with some embodiments.

In operation 203, non-zero values in the locations indicated by the location information are read by the processing circuits 151 for the activation operation. In some embodiments, the input feature maps 310 include padding elements 302 having zero values around the core portion 311. Accordingly, activation values corresponding to padding elements in the top layer 320 (also referred to as a zero layer, not shown in the FIG. 5) in the segment 136 are not transmitted to the processing circuits 151. The non-zero values are read in sequence. For example, the non-zero values in the top layer 320 (below the zero layer) in the input feature maps 310 corresponding to the time step T1 are accessed and transmitted to the PE array 150. Meanwhile, one of groups 530a-530b of filters 531 of weight values are accessed and transmitted to the PE array 150 from the memory circuit 130. In some embodiments, each of the groups 530a-530b includes an identical number of filters, for example, 32 filters 531, in which each of the filters 531 includes kernels 533 having a dimension of 3 times 3. In some embodiments, the same rows, for example the second rows in FIG. 5, in the kernels are referred to as a layer 532 of the filter 531.

In operation 204, as shown in FIG. 5, for example, the processing circuits 151 perform the activation operation (e.g., convolution operation) with the group 530a of filters of weight values and a number of layers 320 of activation values to generate corresponding membrane potentials to be stored in one of layers 157 in one of segments 156 of the membrane buffer memory circuit 155. In some embodiments, each of the segments 156 correspond to one of the time steps T1-T4.

Specifically, in the embodiments of FIG. 5, the processing circuits 151 perform the activation operation with the second layer 532 in the group 530a of filters of weight values with one of the layers 320, for example, the first layer, in the stage 501, perform the activation operation with the third layer in the group 530a of filters of weight values and another layer of the layers 320, for example, the second layer, in the stage 502, and accordingly, generate the membrane potential. In some embodiments, the activation operation includes a matrix multiplication with activation values and weight values.

Based on the above, the activation operation is performed in a number of cycles on rows including the non-zero values, and the number of cycles is associated with count numbers corresponding to the rows including the non-zero number. For example, with reference to FIG. 3, the rows ROW1 of the first layer in the input feature maps 310 of the first and second channels corresponding to the time step T1 have a total of 4 non-zero values that are sent to the PE array 150, and the sum of count numbers of the two rows mentioned above is 4. Accordingly, the processing circuits 151 of the PE array 150 perform the activation operation in 4 cycles.

After the corresponding membrane potentials are generated, during the stage 503, the operation 206 of the method 200 is performed to generate an output spike to provide a neural network result. In some embodiments, the value of the output spike is stored in one of the memory circuits 135 and 140.

During the stage 504, the operations in the stage 501 to the stage 503 are performed for the input feature maps 310 corresponding to other time steps, for example, T2-T4.

In some embodiments, the operation 205 of the method 200 is performed after the stage 502 to update the membrane potentials by adding up with membrane potentials corresponding to a previous time step when the activation values being convolved are not corresponding to the initial time step (e.g., the time step T1). For example, the membrane potentials corresponding to the time step T2 stored in the segment 156 are the sum of the membrane potentials that correspond to the time step T2 and are generated at the stage 502 and the membrane potentials corresponding to the time step T1.

In the following stages 505 to 508, the operation 207 is performed to repeat the operations 203-206 as mentioned above until all of the groups 530a-530b of filters of weight values and all of the layers in the input feature maps 310 corresponding to all time steps T1-T4 are convolved. Specifically, in the embodiments of FIG. 5, the processing circuits 151 perform the activation operation with the first layer 532 in the group 530a of filters of weight values with one of the layers 320, for example, the first layer, in the stage 505, perform the activation operation with the second layer in the group 530a of filters of weight values and another layer of the layers 320, for example, the second layer, in the stage 506, perform the activation operation with the third layer in the group 530a of filters of weight values and yet another layer of the layers 320, for example, the third layer, in the stage 507. and accordingly, generate the membrane potential. The operations in the stage 508 are configured with respect to, for example, the operations in the stages 503-504.

Based on the above, in response to performing the activation operation to different portions of activation values, the corresponding output spikes are generated at different timing.

In some embodiments, the method 200 further includes operations of eliminating the membrane potentials corresponding to the number of the layers associated with a time step before the previous time step. For example, with reference to FIG. 5, after the membrane potentials corresponding to the time step T2 are updated in the operation 205 and generate a corresponding output spike in the operation 206, the membrane potentials in the layer 157 corresponding to the first and second layers in the segment 136 processed in the stages 501-502 are eliminated. Accordingly, less memory resources are occupied by the SNN.

In certain techniques of Spiking Neural Networks (SNN), a clock gating control scheme is employed to intermittently carry out convolution operation on the activation values. This is done to minimize the power consumption of the operation, but it has the drawback of reducing the efficiency of the operation. Conversely, another approach of the SNN involves using complex algorithms to expedite the pruning of weight values, which leads to a significant increase in the number of accesses from the memory when the weight sparsity ratio is low. In yet another architecture of the SNN, all activation values are accessed by the processing elements to generate output spikes, which results in a considerable number of operation cycles. For example, when 96 processing elements perform convolution operation on input feature maps that have a height and width of 32 and a 90% input sparsity ratio with padding one, it takes 393216 cycles to complete the operation. The present application employs a different configuration, where the activation values in the input feature maps are scrutinized by the mask generation circuit to provide location information. Based on this information, only the non-zero values are convolved with weight values, considerably reducing cycle times to less than 10% or less than 39322 cycles, and thereby reducing power consumption and drastically improving the operation speed by at least 10 times in comparison to some of the other approaches mentioned above.

In the context of implementing spiking neural networks (SNNs), a critical challenge is the efficient utilization of storage resources. Specifically, the membrane potentials of the neurons need to be preserved until they undergo convolution operations with all weight values. This process consumes a significant amount of memory space in the membrane buffer memory circuit. The present application proposes to partially provide activation values for convolution operations with one group of weight values, which significantly reduces the memory requirements for the membrane potential storage. Once the output spike is generated, the corresponding membrane potential memory can be released. In other words, these configurations demand less memory resources for SNNs. As an example, with the configurations described in this application, it is demonstrated that this approach requires only 1/64 times the memory space in the circuit as compared to some other methods, according to certain embodiments. Therefore, the application offers a promising solution for optimizing memory utilization in SNNs.

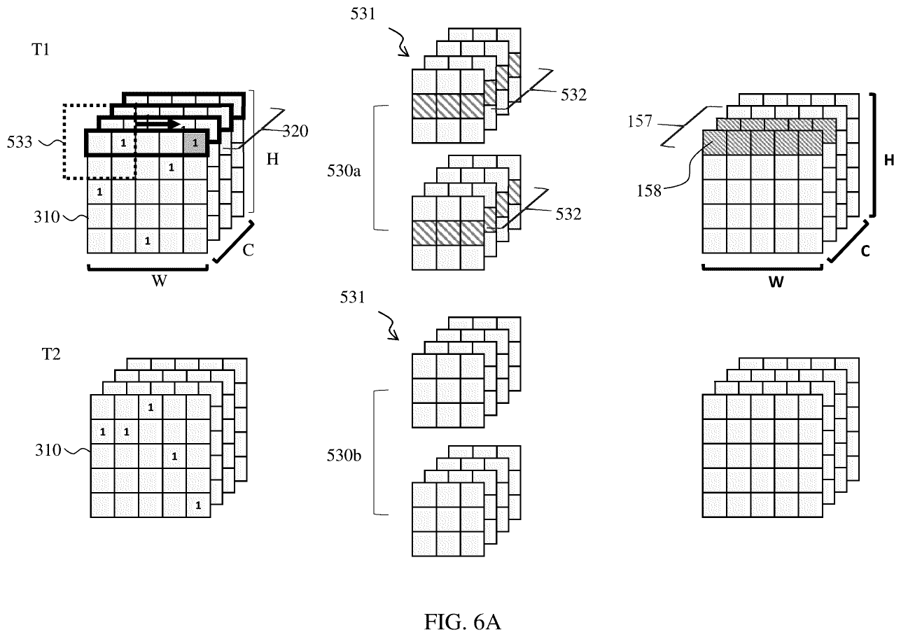

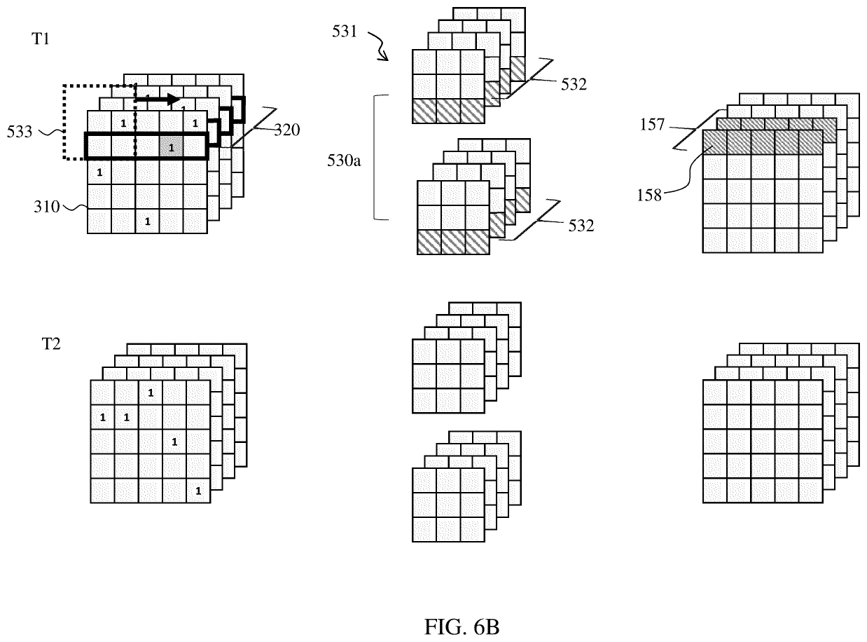

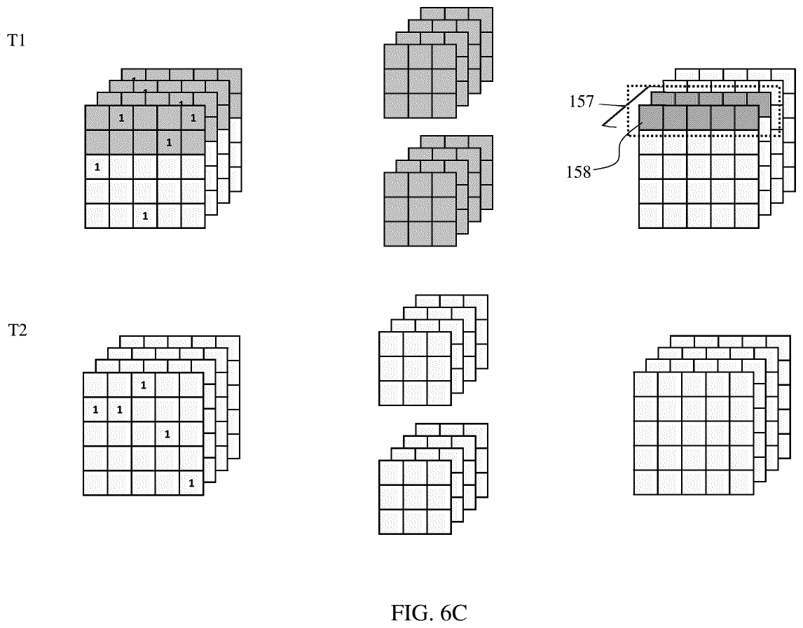

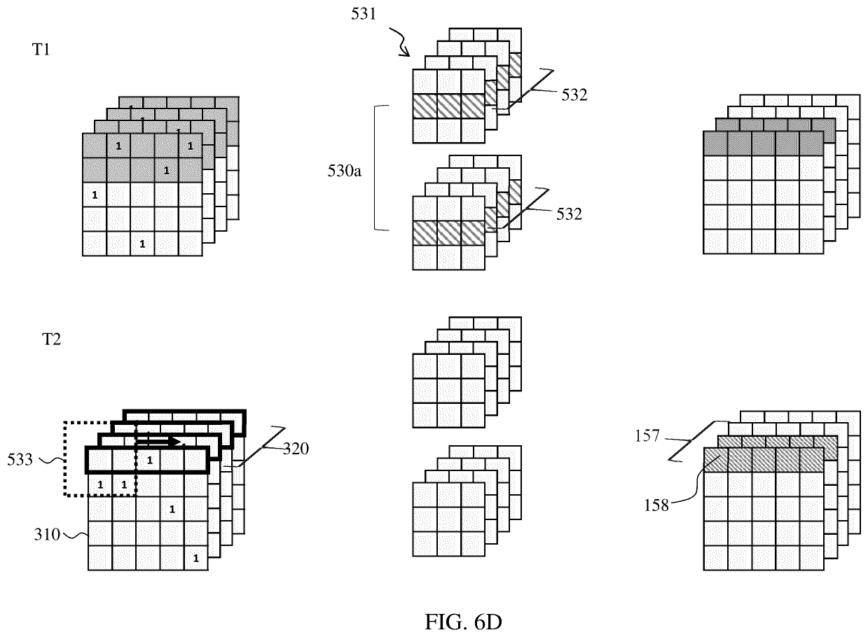

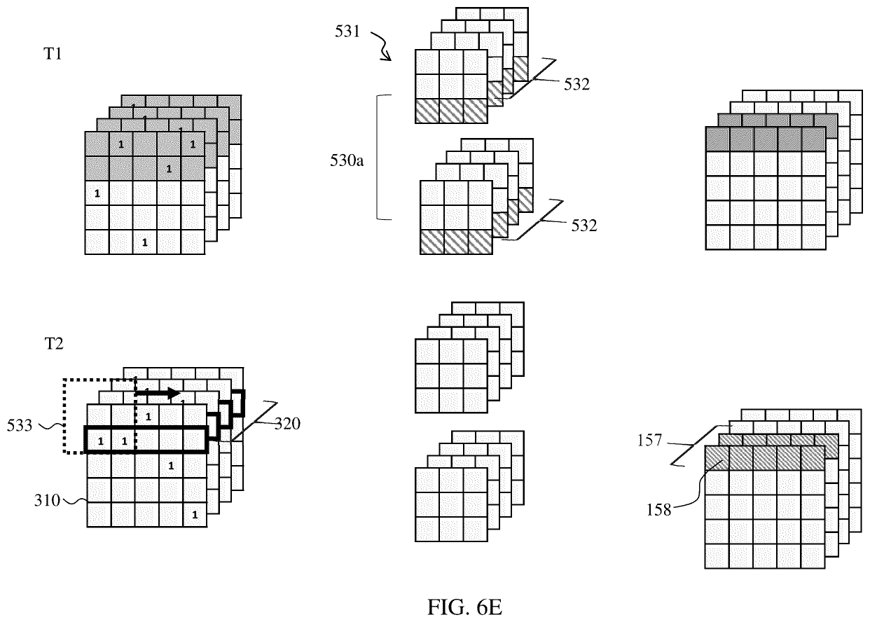

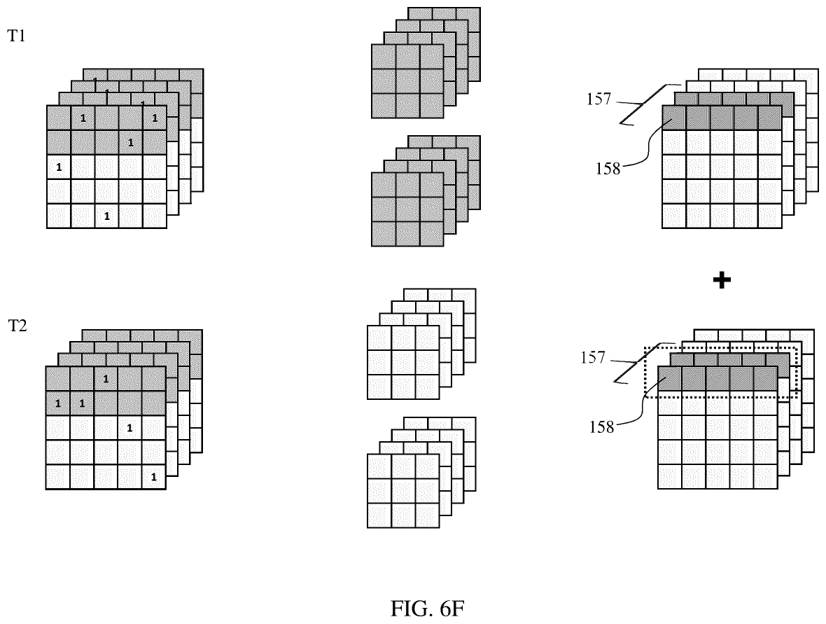

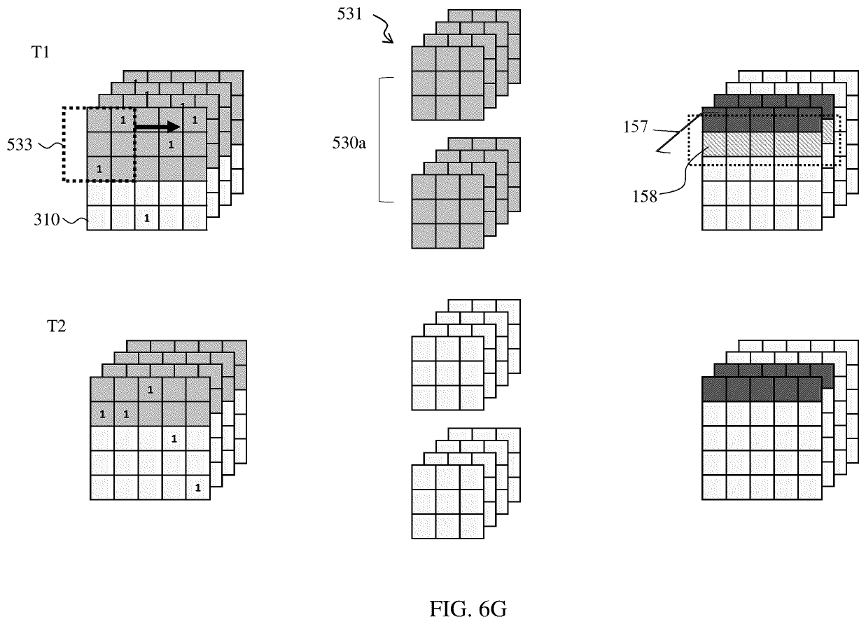

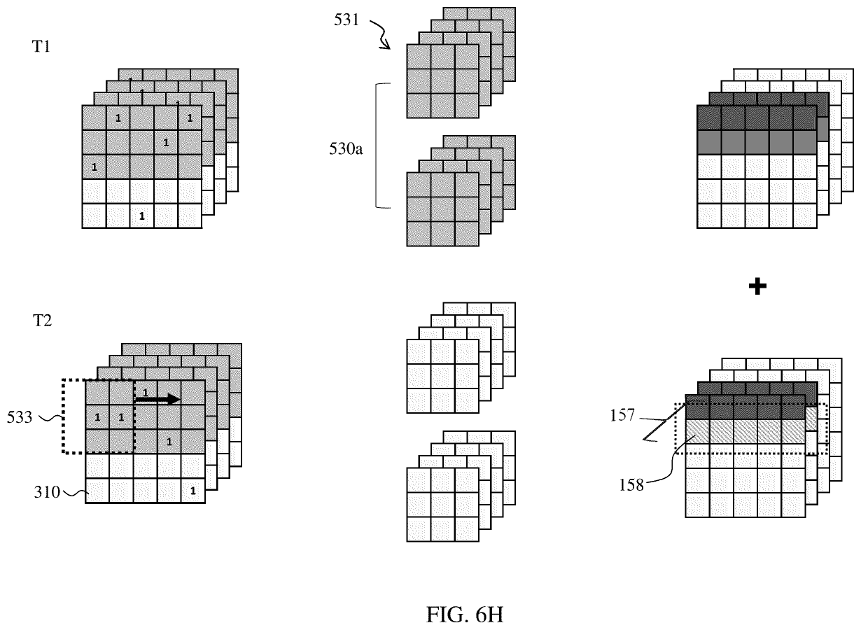

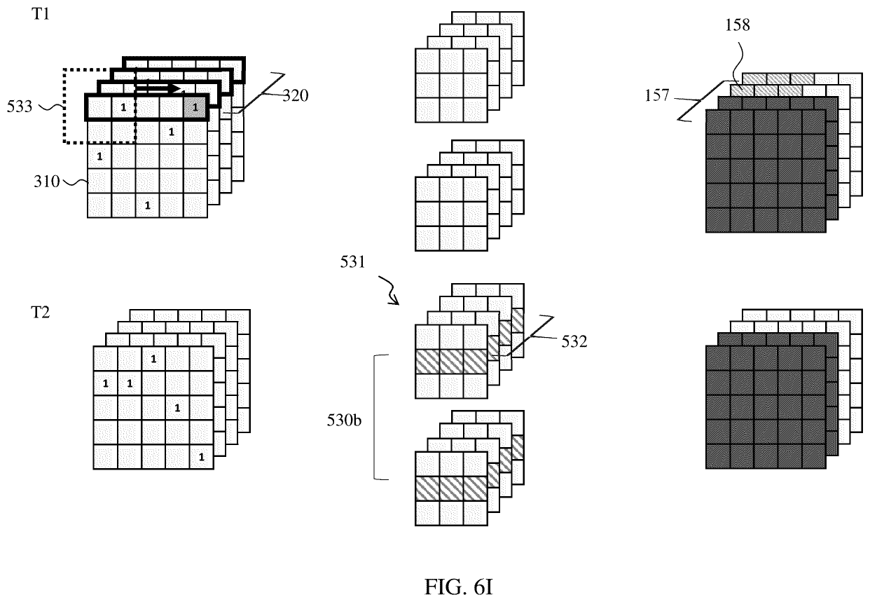

Reference is now made to FIGS. 6A-6I. FIGS. 6A-6I illustrate an example embodiment of activation values in the input features maps 310 to be convolved with filters 531, in accordance with some embodiments. For the sake of brevity, only a few rows and columns of the input feature maps 310, a few kernels in the filters, and a few rows and columns of membrane potentials are shown for illustrative purposes.

As shown in FIGS. 6A-6B, for the time step T1, padding elements (not shown) having zero values are not convolved. non-zero values, based on the location information, in first and second rows (two of the layers 320) of the input feature maps 310 of all channels are convolved with the weight values in corresponding two of the layers 532 of the filters in the group 530a to generate membrane potentials stored in elements 158 of the layer 157 in the segments 156, corresponding to the time step T1. of the membrane buffer memory circuit 155. Specifically, each of the input feature map 310 is convolved with a corresponding kernel map in the filters 531 of the group 530a. Accordingly, in the embodiments shown in FIG. 6C, the neuron core circuit 160 generates/fires an output spike based on the values of the membrane potentials stored in the elements 158 (circled).

As shown in FIGS. 6D-6F, for the time step T2, padding elements (not shown) having zero values are not convolved. non-zero values, based on the location information, in first and second rows (two of the layers 320) of the input feature maps 310 of all channels are convolved with the weight values in corresponding two of the layers 532 of the filters in the group 530a to generate membrane potentials stored in elements 158 of the layer 157 in the segments 156, corresponding to the time step T2, of the membrane buffer memory circuit 155. Furthermore, the membrane potentials generated based on convolution operation corresponding to the time step 2 are updated by adding up with membrane potentials generated based on convolution operation corresponding to the time step 1. Accordingly, in the embodiments shown in FIG. 6F, the neuron core circuit 160 generates/fires an output spike based on the updated values of the membrane potentials stored in the elements 158 (circled).

In some embodiments, after the output spike is generated, the values in the elements 158 corresponding to the time steps T1 and T2 are eliminated to save memory resources as those values are no long utilized to generate other output spikes.

After the operations illustratively shown in FIGS. 6A-6F, in the embodiments of FIG. 6G, for the time step T1, non-zero values, based on the location information, in first to third rows (three of the layers 320) of the input feature maps 310 of all channels are convolved with the weight values in corresponding three of the layers 532 of the filters in the group 530a to generate membrane potentials stored in elements 158 of the layer 157 in the segments 156, corresponding to the time step T1, of the membrane buffer memory circuit 155. Accordingly, the neuron core circuit 160 generates/fires an output spike based on the values of the membrane potentials stored in the elements 158 (circled).

In the embodiments of FIG. 6H, for the time step T2, non-zero values, based on the location information, in first to third rows (three of the layers 320) of the input feature maps 310 of all channels are convolved with the weight values in corresponding three of the layers 532 of the filters in the group 530a to generate membrane potentials stored in elements 158 of the layer 157 in the segments 156, corresponding to the time step T2, of the membrane buffer memory circuit 155. Furthermore, the membrane potentials generated based on convolution operation corresponding to the time step 2 are updated by adding up with membrane potentials generated based on convolution operation corresponding to the time step 1. Accordingly, the neuron core circuit 160 generates/fires an output spike based on the values of the membrane potentials stored in the elements 158 (circled).

After every layer 320 in the input feature maps 310 corresponding to all of the time steps are convolved with the group 530a of the filters of the weight values, the non-zero values of the activation values in the input feature maps 310 are further convolved with another group 530b of filters 531 in sequence in a way similar to what are illustratively shown through FIGS. 6A-6H. The configurations are similar, and hence, the repetitious descriptions are omitted here.

The configurations of FIGS. 5-61 are given for illustrative purposes. Various implements are within the contemplated scope of the present disclosure. For example, in some embodiments, the filters 531 are divided into more than two groups.

Reference is now made to FIG. 7. FIG. 7 is a block diagram illustrating an example of a device 700, for data processing, used to implement embodiments as described herein with reference to FIGS. 1-61. In some embodiments, the device 700 is configured with respect to the device 100 of FIG. 1. As pictured, device 700 includes at least one processor, e.g., a central processing unit (CPU), 705 coupled to memory device 710 through a system bus 715 or other suitable circuitry. Device 700 stores computer readable instructions (also referred to as “program code”) within memory device 710. Memory device 710 may be considered an example of computer readable storage media. Processor 705 executes the program code accessed from memory device 710 via system bus 715. In some embodiments, the processor 705 is configured with respect to, for example, the processor 181 of FIG. 1, and the memory device 710 is configured with respect to, for example, the memory 182 of FIG. 1. In some embodiments, memory circuits of the neural network processor 120 in FIG. 1 are integrated into the memory 182 and other portions of the neural network processor 120 are integrated into the processor 181. In various embodiments, the device 700 further includes another processor configured with respect to, for example, the neural network processor 120.

Memory device 710 may include one or more physical memory devices such as, for example, a memory 720 and one or more bulk storage devices 725. Memory 720 refers to random access memory (RAM) or other non-persistent memory device(s) generally used during actual execution of the program code. Bulk storage device 725 may be implemented as a hard disk drive (HDD), solid state drive (SSD), or other persistent data storage device. Device 700 may also include one or more cache memories (not shown) that provide temporary storage of at least some program code in order to reduce the number of times program code must be retrieved from bulk storage device 725 during execution.

Input/output (I/O) devices such as a keyboard 730, a display device 735, a pointing device 740, and one or more network adapters 745 may be coupled to device 700. The I/O devices may be coupled to device 700 either directly or through intervening I/O controllers. In some cases, one or more of the I/O devices may be combined as in the case where a touchscreen is used as display device 735. In that case, display device 735 may also implement keyboard 730 and pointing device 740. Network adapter 745 may be used to couple device 700 to other systems, computer systems, remote printers, and/or remote storage devices through intervening private or public networks. Modems, cable modems, Ethernet cards, and wireless transceivers and/or radios are examples of different types of network adapter 745 that may be used with device 700. Depending upon the particular implementation of device 700, the specific type of network adapter, or network adapters as the case may be, will vary.

As pictured in FIG. 7, memory device 710 may store an operating system 750 and one or more applications 755. Application 755, for example, may be a neural network utility that, when executed, partitions a neural network. In one aspect, operating system 750 and application 755, being implemented in the form of executable program code, are executed by device 700 and, in particular, by processor 705. As such, operating system 750 and application 755 may be considered an integrated part of device 700. Operating system 750, application 755, and any data items used, generated, and/or operated upon by device 700 are functional data structures that impart functionality when utilized by device 700.

In one aspect, device 700 may be a computer or other device that is suitable for storing and/or executing program code. Device 700 may represent any of a variety of computer systems and/or devices that include a processor and memory and that are capable of performing the operations described within this disclosure. In some cases, the particular computer system and/or device may include fewer components or more components than described. Device 700 may be implemented as a single system as shown or as a plurality of networked or interconnected systems each having an architecture the same as, or similar to, that of device 700.

In one example, device 700 may receive a neural network as an input. Device 700, in executing operating system 750 and application 755, may partition the neural network and store the partitioned neural network within a memory or other computer-readable storage medium for later execution.

For practical applications, the method 200 and the neural network provided in the disclosure can be utilized in various fields such as machine vision, image classification, or data classification. For example, these methods and the neural network can be used in classifying medical images. For example, they can be used to classify X-ray images in normal conditions, with pneumonia, with bronchitis, or with heart disease. The methods can also be used to classify ultrasound images with normal fetuses or abnormal fetal positions. On the other hand, the method 200 and the neural network can also be used to classify images collected in automatic driving, such as distinguishing normal roads, roads with obstacles, and road conditions images of other vehicles. Furthermore, the method 200 and the neural network system can be utilized in other similar fields, such like music spectrum recognition, spectral recognition, big data analysis, data feature recognition and other related machine learning fields.

Another embodiment in the disclosure is a non-transitory computer-readable medium (for example, the memory 182 in FIG. 1 and the memory device 710 in FIG. 7) containing at least one instruction program, which is executed by a processor (for example, the processor 181 in FIG. 1 and the processor 705 in FIG. 7) to perform the method 200 in the embodiments shown in FIGS. 2-61.

As described above, the present application introduces a configuration for spiking neural networks (SNNs) that enhances the efficiency of the network's operation. This configuration utilizes a mask generation circuit that scrutinizes the activation values present in the input feature maps. This circuit provides location information, enabling convolution with only non-zero values. Consequently, this results in a significant reduction in cycle times. Moreover, this reduction in cycle times leads to reduced power consumption. In addition, this configuration proposes to partially provide activation values and weight values, leading to a decrease in memory requirements for membrane potential storage in SNNs. Specifically, the reduced memory requirement occurs because the activation values required for convolution operations with a specific group of weight values are only partially provided. This results in less memory being required to store membrane potentials until the convolution operation is performed. Once the output spike is generated, the corresponding membrane potential memory can be released, resulting in fewer memory resources being required for SNNs. Overall, these configurations offer significant improvements in operation speed and memory utilization compared to other existing configurations, making them an attractive option for implementing efficient SNNs.

In some embodiments, a method is provided and includes operations as below: receiving an input in an input layer of a spiking neural network during a plurality of time steps, wherein the input includes a plurality of spikes; generating, based on a plurality of activation values corresponding to the plurality of spikes, location information including a plurality of count numbers each corresponding to non-zero values, in the plurality of activation values, in one of a plurality of rows of the input; performing, based on the location information, a matrix multiplication with the non-zero values in a first number of rows in the plurality of rows with a first group of filters of weight values to generate a plurality of first membrane potentials for outputting a first output spike at a first time; and performing, based on the location information, the matrix multiplication with the non-zero values in a second number of rows in the plurality of rows with the first group of filters of weight values to generate a plurality of second membrane potentials for outputting a second output spike at a second time after the first time.

In some embodiments, a non-transitory computer-readable medium for storing computer-executable instructions is provided. The computer-executable instructions when executed by a processor implementing a method including: (a) reading a plurality of input feature maps corresponding to a plurality of time steps from a memory device; (b) performing an activation operation with one of groups of filters of weight values and a number of layers in the plurality of input feature maps to generate corresponding membrane potentials in a plurality of membrane potentials, wherein the one of groups of filters of weight values and the number of the layers in plurality of input feature maps correspond to one of the plurality of time steps; (c) when the one of the plurality of time steps in step (b) is not an initial time step in the plurality of time steps, updating the corresponding membrane potentials in step (b) by adding up with membrane potentials corresponding to a previous time step; (d) generating one of a plurality of output spikes to provide a neural network result; and (e) repeating steps (b) to (d) until the activation operation is performed to all of groups of filters of weight values and all of the layers in the plurality of input feature maps.

In some embodiments, a neural network system is provided, including a mask generation circuit, seconod and third memory circuits, and a plurality of processing circuits. The mask generation circuit generates, according to a plurality of activation values corresponding to a plurality of spikes, location information to a first memory circuit. The seconod and third memory circuits store first and second portions of a plurality of activation values respectively. The plurality of processing circuits perform, based on the location information, an activation operation on the first and second portions of the plurality of activation values alternatively with a plurality of weight values to generate a plurality to first membrane potentials and a plurality to second membrane potentials to be stored in a fourth memory circuit. The second memory circuit is further configured to store a plurality of first output values corresponding to the plurality of second membrane potentials generated based on the second portion of the plurality of activation values stored in the third memory circuit.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
receiving an input in an input layer of a spiking neural network during a plurality of time steps, wherein the input includes a plurality of spikes;
generating, based on a plurality of activation values corresponding to the plurality of spikes, location information including a plurality of count numbers each corresponding to non-zero values, in the plurality of activation values, in one of a plurality of rows of the input;
performing, based on the location information, a matrix multiplication with the non-zero values in a first number of rows in the plurality of rows with a first group of filters of weight values to generate a plurality of first membrane potentials for outputting a first output spike at a first time; and
performing, based on the location information, the matrix multiplication with the non-zero values in a second number of rows in the plurality of rows with the first group of filters of weight values to generate a plurality of second membrane potentials for outputting a second output spike at a second time after the first time.

2. The method of claim 1, wherein the first number is different from the second number.

3. The method of claim 1, wherein the first number is smaller than the second number.

4. The method of claim 1, wherein the location information further includes a plurality of channel numbers and a plurality of height numbers, wherein each of the channel numbers and a corresponding height number correspond to a location of the one of the plurality of rows.

5. The method of claim 1, further comprising:
performing, based on the location information, the matrix multiplication with the non-zero values in the first number of rows in the plurality of rows with a second group of filters of weight values to generate a plurality of third membrane potentials for outputting a third output spike at a third time after the second time.

6. The method of claim 5, wherein a number of filters in the first group equals to a number of filters in the second group.

7. The method of claim 5, further comprising:
performing, based on the location information, the matrix multiplication with the non-zero values in the first number of rows in the plurality of rows with a third group of filters of weight values to generate a plurality of fourth membrane potentials for outputting a fourth output spike at a fourth time after the third time.

8. The method of claim 1, further comprising:
generating a neural network result, based on the first and second output spikes, for an image recognition operation of the input.

9. A non-transitory computer-readable medium for storing computer-executable instructions, the computer-executable instructions when executed by a processor implementing a method comprising the following steps:
(a) reading a plurality of input feature maps corresponding to a plurality of time steps from a memory device;
(b) performing an activation operation with one of groups of filters of weight values and a number of layers in the plurality of input feature maps to generate corresponding membrane potentials in a plurality of membrane potentials,
wherein the one of groups of filters of weight values and the number of the layers in the plurality of input feature maps correspond to one of the plurality of time steps;
(c) when the one of the plurality of time steps in step (b) is not an initial time step in the plurality of time steps, updating the corresponding membrane potentials in step (b) by adding up with membrane potentials corresponding to a previous time step;
(d) generating one of a plurality of output spikes to provide a neural network result; and
(e) repeating steps (b) to (d) until the activation operation is performed to all groups of filters of weight values and all of the layers in the plurality of input feature maps.

10. The non-transitory computer-readable medium of claim 9, wherein the method further comprises the following steps:
(f) generating, based on the plurality of input feature maps, location information; and
(g) reading non-zero values in locations indicated by the location information for step (b).

11. The non-transitory computer-readable medium of claim 10, wherein the location information includes a plurality of count numbers each corresponding to the non-zero values in one of a plurality of rows, a plurality of channel numbers and a plurality of height numbers, wherein each of the channel numbers and a corresponding height number correspond to a location of the one of the plurality of rows.

12. The non-transitory computer-readable medium of claim 10, wherein the step (f) comprises a step:
(h) counting the non-zero values in a plurality of rows of the plurality of input feature maps to generate a plurality of count numbers included in the location information.

13. The non-transitory computer-readable medium of claim 12, wherein in step (b) the activation operation is performed in a number of cycles on rows including the non-zero values,
wherein the number of cycles is associated with count numbers corresponding to the rows including the non-zero values.

14. The non-transitory computer-readable medium of claim 9, wherein the method further comprises a step:
(f) eliminating the membrane potentials corresponding to the number of the layers associated with a time step before the previous time step.

15. A system, comprising:
a mask generation circuit configured to generate, according to a plurality of activation values corresponding to a plurality of spikes, location information to a first memory circuit;
second and third memory circuits that are configured to store first and second portions of a plurality of activation values respectively; and
a plurality of processing circuits configured to perform, based on the location information, an activation operation on the first and second portions of the plurality of activation values alternatively with a plurality of weight values to generate a plurality of first membrane potentials and a plurality of second membrane potentials to be stored in a fourth memory circuit,
wherein the second memory circuit is further configured to store a plurality of first output values corresponding to the plurality of second membrane potentials generated based on the second portion of the plurality of activation values stored in the third memory circuit.

16. The system of claim 15, further comprising:
a controller circuit configured to send a control signal associated with the locations to the plurality of processing circuits to read non-zero values in the plurality of activation values as the first and second portions of the plurality of activation values.

17. The system of claim 16, wherein the first portion of the plurality of activation values are included in two rows of a plurality of input feature maps corresponding to one of a plurality of time steps, and
the second portion of the plurality of activation values is included in two rows of the plurality of input feature maps corresponding to another time step of the plurality of time steps.

18. The system of claim 16, wherein the first portion of the plurality of activation values are included in three rows of a plurality of input feature maps corresponding to one of a plurality of time steps, and
the second portion of the plurality of activation values is included in three rows of the plurality of input feature maps corresponding to another time step of the plurality of time steps.

19. The system of claim 15, wherein the plurality of weight values are divided into N groups, and the plurality of processing circuits are further configured to perform the activation operation on the first portion of the plurality of activation values with one group, in the N groups, of weight values to generate the plurality of first membrane potentials,
wherein the system further comprises:
a neuron core circuit configured to generate an output spike based on the plurality of first membrane potentials.

20. The system of claim 19, wherein each of the N groups includes M number of filters, and
a number of the plurality of processing circuits is associated with a product of the number M and a dimension of the filters.
